(19) United States
(12) Patent Application Publication
(10) Pub. No.: US 2010/0170480 A1
(43) Pub. Date: Jul. 8, 2010

(54) HIGH-PRESSURE FUEL PUMP WITH ROLLER TAPPET

(76) Inventors: Eberhard Maier, Koengen (DE); Bernd Haeusser, Neckarwestheim (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/663,671

(22) PCT Filed: Jun. 13, 2008
(86) PCT No.: PCT/EP08/57457

§ 371 Date: Dec. 8, 2009

(30) Foreign Application Priority Data
Jul. 20, 2007 (DE) 10 2007 034 036.4

(51) Int. Cl. F02M 37/06; F04B 9/04; F04B 17/05

(52) U.S. Cl. 123/508; 417/364

(57) ABSTRACT

A radial piston pump with a roller tappet in which the service life of the tappet is increased by delivering fuel to the contact faces between the tappet and the roller by way of a hydraulic connection between the tappet chamber and the engine chamber.

### PRIOR ART

The invention relates to a radial piston pump for generating high fuel pressure in fuel injection systems of internal combustion engines, in particular in a common rail injection system, having a drive shaft, supported in a pump housing, which braces at least one piston disposed radially, relative to the drive shaft, in a respective element bore, which pistons are movable radially back and forth in the respective element bore by rotation of the drive shaft, and having one roller tappet disposed between each of the pistons and the drive shaft and guided in the pump housing.

A radial piston pump of this kind is known for instance from German Patent Disclosure DE 103 56 262 A1. In this radial piston pump, the tappets and the pump housing each define a respective tappet chamber, inside which a spring, among other items, is located that keeps the tappet in contact with the drive shaft or camshaft. Since the tappets make the oscillating motion of the pistons of the radial piston pump as well, the volume of the tappet chambers varies periodically.

To minimize the friction between the tappet and the drive shaft, a roller is supported slidingly in the tappet, and the roller rolls on the cams of the drive shaft.

### DISCLOSURE OF THE INVENTION

It is the object of the invention to further improve such a radial piston pump with regard to its service life, reliability, wear, and efficiency.

In a radial piston pump for generating high fuel pressure in fuel injection systems, in particular in a common rail injection system, having a drive shaft supported in a pump housing having at least one piston disposed radially in a respective element bore relative to the drive shaft, the at least one piston being movable radially back and forth in the element bore by rotation of the drive shaft, having a tappet disposed between the piston and the drive shaft and guided in the pump housing, and having one tappet chamber per tappet, defined by the tappets and by the pump housing, the tappet chamber being in hydraulic communication with an engine chamber and a depression for receiving a roller being provided on an end of the tappet oriented toward the drive shaft, this object is attained according to the invention in that at least some of the hydraulic connections discharge between the tappet chamber and the engine chamber in the depression.

By the hydraulic connection according to the invention, between the tappet chamber and the engine chamber, that discharges in the depression, fuel is delivered to the contact faces between the tappet and the roller with each reciprocating motion of the tappet. As a result, a cooling flow of lubricant develops, which improves the tribological conditions of the roller, tappet and guide body, and guide bore. Since this flow of lubricant is rpm-dependent, at high rotary speeds of the high-pressure fuel pump, wear of the roller and tappet is averted especially effectively. Should wear nevertheless occur, then the resultant particles are floated away from the wearing point by the fuel delivered with the aid of the oscillating motion of the tappet. As a result, functional problems of the high-pressure fuel pump of the invention from wear at the contact points between the roller and the guide body need not be a concern.

By the additional hydraulic connection between the tappet chamber and the engine chamber, the pressure pulsations in the engine chamber are reduced, which also has a positive effect on the operating behavior of the high-pressure fuel pump.

Moreover, because of the additional hydraulic connection the flow resistance of the tappet in the guide bore is reduced, which reduces the dissipation work caused by the tappet motion. As a consequence, the fuel is not heated up as severely, and the efficiency of the pump is increased.

A further advantage of the hydraulic connection of the invention between the engine chamber and the tappet chamber is that the production costs are low, and furthermore, they can be retrofitted without further problems in high-pressure fuel pumps that are already mass-produced. All that is required is to modify the tappet. All the other components can be adopted without modification.

An especially advantageous feature of the invention provides that the tappet has at least one groove, but preferably one groove on each of the two ends of the depression, and the groove extends essentially in the axial direction of the tappet. As a result, it is possible in the simplest way to produce the hydraulic connection of the invention between the tappet chamber and the depression. Alternatively, it is also possible to make a bore in the tappet, and this bore provides the hydraulic connection of the invention between the tappet chamber and the ends of the depression.

It is especially advantageous if the hydraulic connection on the ends of the depression discharges into the depression, since in that case the fuel delivered by the tappet is supplied directly to the tribologically most-critical points, namely the contact zones between the guide body and the roller. Moreover, in this way particles that have been created from wear between the tappet body and the roller are carried in the best way away from this contact point.

In a further augmentation of the invention it can be provided that in the pump housing, at least one connecting bore is provided, and that the at least one connecting bore connects two tappet chambers hydraulically to one another.

As a result, it is possible to limit the “delivery volume” delivered by the tappets from the engine chamber to the tappet chambers and back. By a suitable adaptation of the flow resistance of the connecting bore and of the hydraulic connection of the invention, the fuel quantity delivered hydraulically according to the invention can be restricted to only the amount necessary, so that the pumping work of the tappets is reduced to only the amount necessary.

In this variant, all that is needed is additionally to make a connecting bore in the pump housing, so that two adjacent tappet chambers communicate hydraulically with one another. By now, this provision can be made in pump housings that are already in mass production as well, so that in some cases, it is possible for mass-production radial piston pumps to be retrofitted with the hydraulic connection bore of the invention.

In addition, it is possible to have a lubricant supply discharge into the hydraulic connection, so that fresh, cool fuel is always being delivered to the tribologically critical contact point between the roller and the guide body.

Alternatively, two tappet chambers can also communicate hydraulically through an external connecting line. This variant is recommended whenever a connecting bore cannot be accommodated in the pump housing for engineering or other reasons.

The function of the radial piston pump of the invention can be further improved if the supply of fuel to the drive shaft for cooling and lubrication, which exists anyway, discharges into the hydraulic connection between two tappet chambers, since in that case a defined quantity of lubricant for lubricating and cooling purposes can be supplied to the tappets and the tappet chambers. As a result, the load capacity of the radial piston pump of the invention increases, at no additional production or manufacturing cost.

In the radial piston pump of the invention, the drive shaft can be embodied as a camshaft or an eccentric shaft. It is equally possible to provide the tappets with a roller which rolls on the camshaft, so that the forces of friction between the tappet and the camshaft are reduced.

Further advantages, characteristics and details of the invention will become apparent from the ensuing description, in which a plurality of exemplary embodiments of the invention are described in detail in conjunction with the drawings. The characteristics recited in the claims and mentioned in the specification can be essential to the invention each individually or in arbitrary combination.

The drawings show:

### DRAWINGS

FIG. 1, a section through one exemplary embodiment of a radial piston pump according to the invention;

FIG. 2, an enlarged view of a roller tappet according to the invention

### EMBODIMENTS OF THE INVENTION

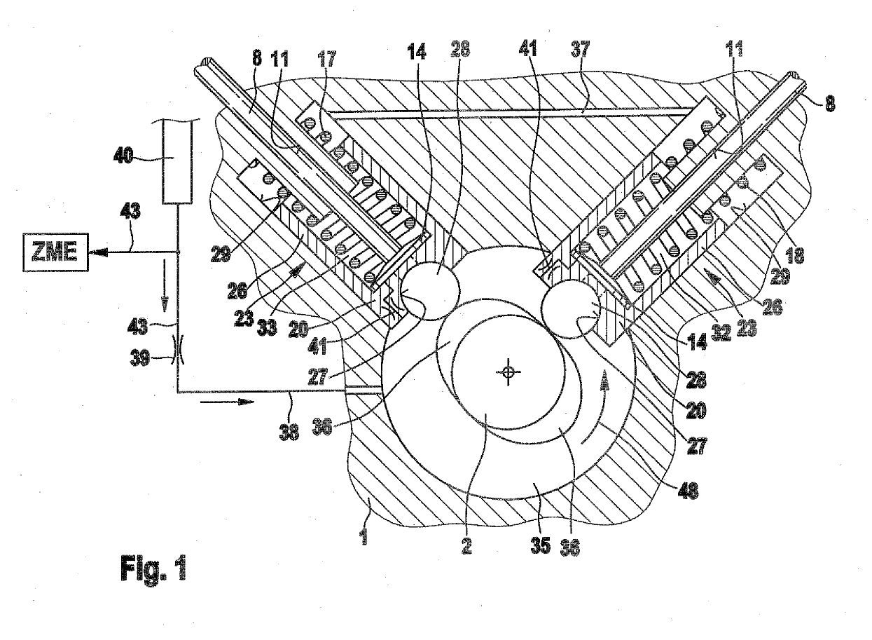

FIG. 1, in section, schematically shows a radial piston pump for supplying fuel at high pressure in fuel injection systems, in particular common rail fuel injection systems, of internal combustion engines. The radial piston pump shown in FIG. 1 is equipped with an integrated demand quantity regulator. The delivery quantity regulator is effected on the low-pressure side via a metering unit ZME.

The radial piston pump shown in FIG. 1 includes a drive shaft 2, supported in a pump housing 1, with two cams 36 offset by 180° from one another. Two pistons 8 are supported against the cams 36. The pistons 8 are each received in a respective element bore 11 movably back and forth in the radial direction. The pistons 8 are disposed at an angle of approximately 90° to one another, and on their end remote from the drive shaft 2 they define a pumping chamber (not shown).

On the end of the pistons 8 oriented toward the drive shaft 2, the pistons 8 are braced against a bottom 20 of a tappet 23. To improve the transmission of force between the pistons 8 and the bottom 20 of the tappet 23, a plate 14 is provided on the piston 8. This plate 14 can either be integral with the piston 8 or can be secured removably to it. A spring 17 is prestressed against the plate 14. The springs 17 press the pistons 8 against the bottoms 20 of the tappets 23. From the bottoms 20 of the tappets 23, a cylindrical guide body 26 extends in the direction of the delivery chambers, not shown. The guide bodies 26 are part of the tappets 23 and prevent tilting of the tappets 23 in a guide bore 29. The tappets 23 are displaceable in the pump housing 1.

In the bottoms 20 of the tappets 23, there is a half-round depression 27, which serves to support a roller 28. The depression 27 and the roller 28 form a slide bearing, while the roller 28 rolls on the cam 36 of the drive shaft 2. In the lateral direction, the roller 28 is fixed in the guide body 26. A relative motion takes place between the face ends of the roller 28 and the guide body 26, and this motion can cause wear.

The radial piston pump shown in FIG. 1 serves to subject fuel, which is furnished by a prefeed pump from a tank, to high pressure. In the delivery stroke, the pistons 8, because of the eccentric motion of the cams 36 of the drive shaft 2, are moved away from the axis of rotation of the drive shaft or camshaft 2. In the intake stroke, the pistons 8 move radially toward the axis of the camshaft 2, in order to aspirate fuel into the delivery chamber, not shown.

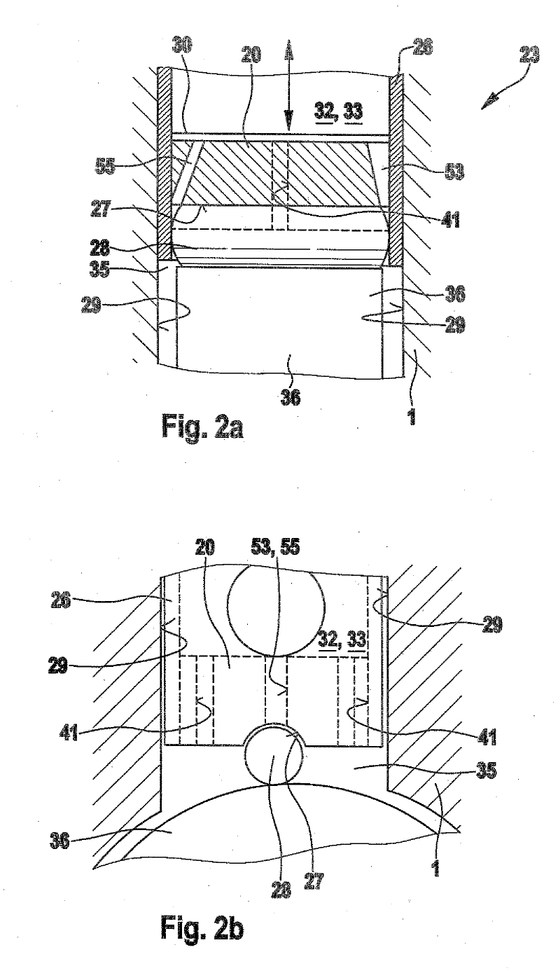

In FIG. 2a, the tappet 23 is shown in longitudinal section, and in FIG. 2b, it is shown in a side view. From the longitudinal section (FIG. 2a) it can readily be seen that in the exemplary embodiment shown, the bottom 20 is inserted into the guide body 26. To make a form-locking connection between the bottom 20 and the guide body 26, a Seeger ring 30 can be provided.

As can also be seen from the longitudinal section, the roller 28 is rounded on its face ends and is fixed in the lateral direction by the guide body 26. Because of the oscillating motion of the tappet 23 in the guide bore 29, the face ends of the roller 28 roll on the inside of the guide body 26. To reduce the resultant wear, a hydraulic connection is provided according to the invention between the tappet chambers 32, 33 on the one hand and the depression 28. Moreover, the hydraulic connection of the invention improves the tribological conditions between the roller 28 and the tappet 23.

In FIG. 2a, two variants of hydraulic connections of the invention are shown. On the right-hand side of FIG. 2a, a groove 53 is shown, which supplies the contact point between the roller 28 and the guide body 26 with fuel. On the left-hand side of FIG. 2a, an alternative embodiment of the hydraulic connection of the invention is shown, in the form of a bore 55, which supplies the contact point between the roller 28 and the guide body 26 with fuel. As a rule, both sides of a tappet 23 will be designed identically. The groove 53 and the bore 55 are alternative embodiments of the invention. Which of these alternatives will be given preference in an individual case depends on the circumstances of the individual ease.

Now, if the tappet 23 is driven by the cams 36 of the drive shaft, it executes an oscillation motion, which is indicated by a double arrow in FIG. 2a. Since there is fuel both in the tappet chambers 32, 33 and in the engine chamber 35, the oscillating motion of the tappet 23 causes fuel to be delivered from the engine chamber 35 into the tappet chambers 32 and 33 when the piston is moving from top to bottom in terms of FIG. 2a. As soon as the tappet 23 moves from bottom to top, the flow direction is reversed, and fuel is delivered from the tappet chambers 32, 33 into the engine chamber 35. This necessarily occurring effect is made use of by the hydraulic connection of the invention, whether in the form of the groove 53 or in the form of a bore 55, in that fuel is delivered in a targeted way to the contact point between the roller 28 and the guide body 26. The hydraulic connection of the invention leads to a major reduction in this wear, since the tribologically critical points are lubricated with fuel. Moreover, if wear does still occur, the resultant particles are immediately flushed out of the contact area between the roller 28 and the guide body 26, so that they do no further damage there.

Moreover, the dissipation losses, which occur upon pumping of fuel from the tappet chambers 32, 33 into the engine chamber 35 and back, are reduced markedly, so that the pumping efficiency is improved, and the fuel is not heated up so severely.

Because of the angle of 90° between the pistons 8 and 9, the volumetric changes in the tappet chambers 32 and 33 take place with a 90° phase displacement. This phase displacement can be utilized by providing a connecting bore 37 between the tappet chambers 32 and 33, so that whenever the volume in one tappet chamber is decreasing, the fuel located in that tappet chamber is partially expelled into the adjacent tappet chamber, whose volume is increasing at the same time. The other portion of the fuel flows through the groove 53 or the bore 55 and the compensation bores 41 (if present) the bottom 20 of the tappets 23 and 24.

Care should be taken to assure, by the suitable adaptation of the hydraulic cross sections of the groove 53 or bore 55, the compensation bores 41, and the connecting bore 37 between the tappet chambers 32 and 33, that a sufficiently large quantity of fuel flows through the groove 53 or the bores 55 to reduce the wear in the contact area between the roller 28 and the guide body 26 sufficiently.

In this exemplary embodiment, the lubrication of the camshaft 2 and its support (not shown) takes place via a lubricant supply 38 with a throttle restriction 39, which is fed directly with fuel from the fuel tank, not shown, of the engine via a supply line 40. A line 43, which supplies the metering unit ZME of the radial piston pump with fuel, branches off from the supply line 40.

1-9. (canceled)

10. A radial piston pump for generating high fuel pressure in fuel injection systems of internal combustion engines, in particular in a common rail injection system, having a drive shaft supported in a pump housing, having at least one piston disposed radially relative to the drive shaft in a respective element bore, the at least one piston being movable radially back and forth in the element bore by rotation of the drive shaft, having a tappet disposed between the piston and the drive shaft and guided in the pump housing, having one tappet chamber per tappet, defined by the tappet and by the pump housing, the tappet chamber being in hydraulic communication with an engine chamber via hydraulic connections, a depression for receiving a roller being provided on an end of the tappet oriented toward the drive shaft, wherein at least some of the hydraulic connections discharge between the tappet chamber and the engine chamber in the depression.

11. The radial piston pump as defined by claim 10, wherein the tappet has at least one groove forming a hydraulic connection; and the groove extends essentially in the axial direction of the tappet.

12. The radial piston pump as defined by claim 10, wherein the tappet has at least one bore forming a hydraulic connection; and the bore extends essentially in the axial direction of the tappet.

13. The radial piston pump as defined by claim 10, wherein the depression is located in a bottom of the tappet.

14. The radial piston pump as defined by claim 10, wherein the depression has ends and the hydraulic connections discharge into the depression at said ends.

15. The radial piston pump as defined by claim 10, wherein the pump housing has two tappet chambers and at least one connecting bore is provided in the pump housing; and-the at least one connecting bore hydraulically connects the two tappet chambers

16. The radial piston pump as defined by claim 10, wherein the pump housing has two tappet chambers and a lubricant supply discharges into a hydraulic connection between the two tappet chambers.

17. The radial piston pump as defined by claim 10, wherein the tappet has a compensation bore or a compensation groove.

18. The radial piston pump as defined by claim 10, wherein the drive shaft is embodied as a camshaft.

19. The radial piston pump as defined by claim 10, wherein a roller is located in the depression; the roller and the tappet have contacting faces; and fuel is delivered to the contacting faces via a hydraulic connection.

20. The radial piston pump as defined by claim 19, wherein the hydraulic connection is a groove.

21. The radial piston pump as defined by claim 20, wherein the roller has two ends; each end of the roller has a contacting face which contacts a contacting face of the tappet; the pump has two hydraulic connections; and each hydraulic connection delivers fuel to one end of the roller for lubricating the contacting faces.

22. The radial piston pump as defined by claim 20, wherein the pump housing has two tappet chambers and at least one connecting bore is provided in the pump housing; and the at least one connecting bore hydraulically connects the two tappet chambers.

23. The radial piston pump as defined by claim 19, wherein the hydraulic connection is a bore.

24. The radial piston pump as defined by claim 23, wherein the roller has two ends; each end of the roller has a contacting face which contacts a contacting face of the tappet; the pump has two hydraulic connections; and each hydraulic connection delivers fuel to one end of the roller for lubricating the contacting faces.

25. The radial piston pump as defined by claim 23, wherein the pump housing has two tappet chambers; at least one connecting bore is provided in the pump housing; and the at least one connecting bore hydraulically connects the two tappet chambers.

26. The radial piston pump as defined by claim 19, wherein the roller has two ends; each end of the roller has a contacting face which contacts a contacting face of the tappet; the pump has two hydraulic connections; and each hydraulic connection delivers fuel to one end of the roller for lubricating the contacting faces.

27. The radial piston pump as defined by claim 19, wherein the depression is located in a bottom of the tappet.

28. The radial piston pump as defined by claim 19, wherein the pump housing has two tappet chambers and at least one connecting bore is provided in the pump housing; and the at least one connecting bore hydraulically connects the two tappet chambers.

29. The radial piston pump as defined by claim 19, wherein the pump housing has two tappet chambers and a lubricant supply discharges into a hydraulic connection between the two tappet chambers.
